(19) United States
(12) Patent Application Publication
(10) Pub. No.: US 2016/0125487 A1
(43) Pub. Date: May 5, 2016

(54) OPTIMIZATION OF UTILITY CONSUMPTION FOR PROPERTY

(71) Applicant: Burton Energy Group, Alpharetta, GA (US)

(72) Inventor: Jason Hamby, Alpharetta, GA (US)

(73) Assignee: BURTON ENERGY GROUP, Alpharetta, GA (US)

(21) Appl. No.: 14/528,599

(22) Filed: Oct. 30, 2014

(51) Int. Cl. G06Q 30/04; H04L 12/58; G06Q 50/06; G05B 13/02

(52) U.S. Cl. CPC G06Q 30/04; G05B 13/021; H04L 51/046; G06Q 50/06

(57) ABSTRACT

Disclosed are various embodiments for optimizing utility usage. A computing device parses utility billing data for a property to generate utility consumption data for the property to determine a current utility consumption rate for the property. The computing device analyzes property data for the property to determine an optimum utility consumption rate for the property. The computing device determines that the current utility consumption rate for the property is greater than the optimum utility consumption rate for the property. The computing device determines a list of solutions to reduce the current utility consumption rate for the property to the optimum utility consumption rate for the property. The computing device sends an electronic message to a client computing device associated with the property, wherein the electronic message comprises the list of solutions to reduce the current utility consumption rate for the property to the optimum utility consumption rate for the property.

### BACKGROUND

Utilities, such as electricity, gas, and water, are consumed by business operations. This utility consumption may often form a large portion of a business's operational budget. Utility consumption may further be influenced by any one of a number of factors and individual steps or components of business operations.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a flowchart illustrating one example of functionality implemented as portions of a metadata processor executed in a computing environment in the networked environment of FIG. 1 according to various embodiments of the present disclosure.

FIG. 3 is a flowchart illustrating one example of functionality implemented as portions of the invoice processor executed in a computing environment in the networked environment of FIG. 1 according to various embodiments of the present disclosure.

FIG. 4 is a flowchart illustrating one example of functionality implemented as portions of the utility optimizer executed in a computing environment in the networked environment of FIG. 1 according to various embodiments of the present disclosure.

FIG. 5 is a schematic block diagram that provides one example illustration of a computing environment employed in the networked environment of FIG. 1 according to various embodiments of the present disclosure.

### DETAILED DESCRIPTION

Disclosed are various embodiments for optimizing utility usage incurred at a location, such as a business or residence. Utility usage may be determined based upon sensors at a location and/or utility bills received from a utility provider. The utility usage for the location may be normalized on a calendar month basis and analyzed to identify trends and normal patterns of utility usage. In various embodiments, reports may be generated that break down the utility usage of the location according to one or more metrics previously specified by a client at the location. These reports may include metrics such as utility usage per square foot, utility usage per sales dollar, and/or other utility usage metrics. Due to the nature of the metrics involved in the reports, it is understood that each report for each client is customized to the needs of the client. In various embodiments, analysis of the utility usage of a location may be further automated. When deviations from the normal trend and/or pattern of utility usage, corrective action may be taken. Further, optimizations of utility usage for the location may be undertaken based upon site data associated with the location and/or the identified trends and normal patterns of utility usage. In the following discussion, a general description of the system and its components is provided, followed by a discussion of the operation of the same.

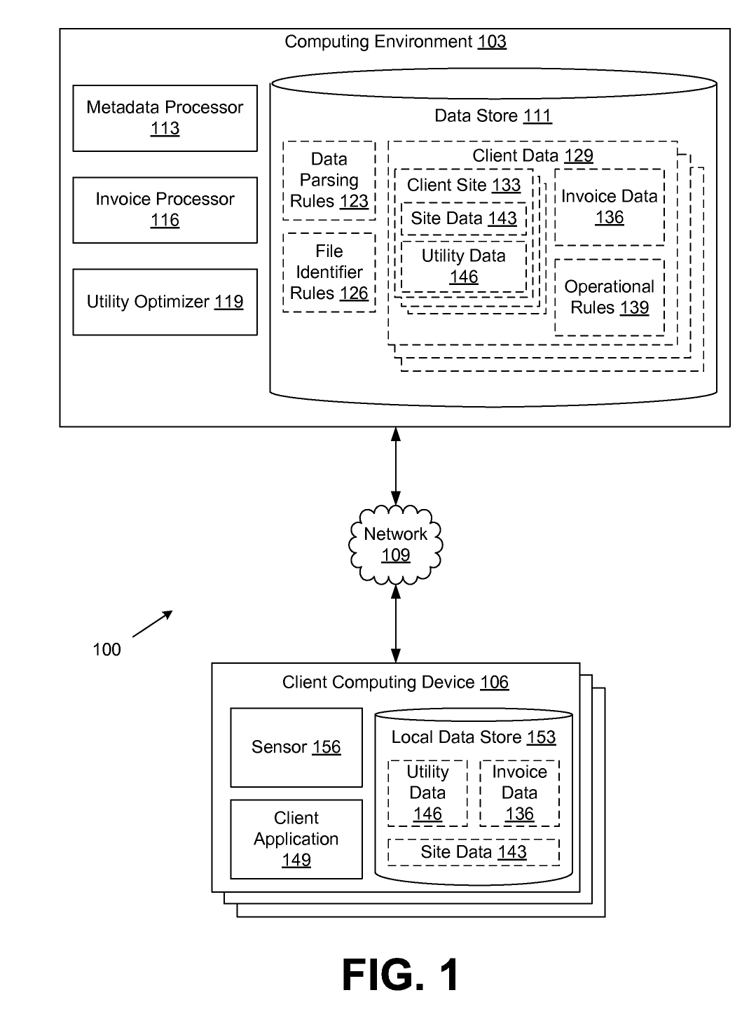

With reference to FIG. 1, shown is a networked environment 100 according to various embodiments. The networked environment 100 includes a computing environment 103, and a client computing device 106, which are in data communication with each other via a network 109. The network 109 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 111 that is accessible to the computing environment 103. The data store 111 may be one of a number of data storage structures, such as flat files, object oriented databases, hierarchical databases, relational databases, and/or other data storage structures. The data store 111 may be representative of a plurality of data stores 111 as can be appreciated. In embodiments involving a plurality of data stores 111, individual data stores 111 may be arranged in a mirrored, clustered, and/or similar arrangement. Individual data stores 111 may further be in data communication with each other and may be distributed among many different geographical locations. The data stored in the data store 111, for example, is associated with the operation of the various applications and/or functional entities described below.

The components executed on the computing environment 103, for example, include a metadata processor 113, an invoice processor 116, a utility optimizer 119, and other applications, services, processes, systems, engines, or functionality not discussed in detail herein. The metadata processor 113 is executed to import data into the data store 111. The invoice processor 116 is executed to normalize utility data received from utility invoices. The utility optimizer 119 is executed to detect deviations in utility usage and to optimize utility usage. The data stored in the data store 111 includes, for example, data parsing rules 123, file identifier rules 126, client data 129, and potentially other data.

The data parsing rules 123 identify how a particular data file or data stream stores data. For each data file or data stream, there is at least one corresponding data parsing rule 123. Data parsing rules 123 may specify how a data file or data stream stores data generally. In some embodiments, data parsing rules 123 may also specify how a particular source of a data file stores data in a data file. As an illustrative and non-limiting example, a first data parsing rule 123 may specify generally how data is stored or formatted in a Microsoft Excel® file, while a second data parsing rule 123 may specify how a Microsoft Excel® file received from a particular source, such as a particular client, stores data within a Microsoft Excel® file.

The file identifier rules 126 represent a format for a data file or data stream and a corresponding identifier. For example, a Microsoft Excel® file may be formatted differently than a Microsoft Access® file, which may formatted differently from an Adobe Portable Document Format (PDF®) file. Accordingly, a first file identifier rule 126 may specify header and format information that can be used to identify a Microsoft Excel® file. A second file identifier rule 126 may specify header and format information that can be used to identify a Microsoft Access® file. A third file identifier rule 126 may specify header and format information that can be used to identify an Adobe PDF file. In addition, other file identifier rules 126 may be used to identify other file types and/or data streams.

The client data 129 represents data for each client whose utility consumption is being optimized. Client data 129 for multiple clients may be stored in the data store 111. Client data 129 may include data for individual client sites 133 of clients, invoice data 136 corresponding to utility usage by clients, and operational rules 139 for clients.

For each client site 133, a corresponding record may be included in the client data 129. Client sites 133 may correspond to one or more locations where a client is consuming utilities. Client sites 133 may correspond to multiple residences owned by an individual, multiple business locations where a business is operating, and/or other locations. Data for client sites 133 may include site data 143 and utility data 146 for the client site 133.

Invoice data 136 corresponds to data extracted and/or derived from utility invoices of a client. Invoice data 136 may include a service provider for utilities, the start and end date of a billing period, the amount of utilities consumed during the billing period, the rate charged for utilities during the billing period, and/or other data. In some embodiments, invoice data 136 may also include digital or digitized copies of the invoices themselves.

Operational rules 139 identify various rules specified by a client for operating the client sites 133 of a client. Operations rules 139 may include reallocating or redistributing resources to minimize utility usage or maximize efficiency. For example, one operational rule 139 may specify that unoccupied floors in a hotel be heated or cooled less in order to conserve electricity. As another example, an operational rule 139 may specify that blinds on east-facing windows be drawn in the morning and that blinds on west-facing windows be drawn in the afternoon during the summer to minimize cooling costs. Similarly, another operation rule 139 may specify that blinds on east-facing windows be open in the morning and that blinds on west-facing windows be open in the afternoon during the winter to minimize the cooling costs. Another operational rule 139 may specify that HVAC systems not run when a building is unoccupied, such as when it is outside of a business's operating hours. In some embodiments, operational rules 139 might specify that one or more area of a client site 133 be pre-cooled before the beginning of operating hours because the site data 143 may indicate that the characteristics of the building client site 133 are such that it is more efficient or inexpensive to pre-cool areas of the client site 133 to avoid reaching peak-loads.

Site data 143 represents non-utility data related to a particular client site 133. Site data 143 may include the square-footage of utility consuming portions of a client site 133, construction materials used at the client site 133, the utility consuming systems located at the client site 133, sales data associated with the client site 133, lease data associated with the client site 133, and/or other data. For example, utility consuming portions of a client site 133 may include the climate-controlled portions of the client site 133, the portions of the client site 133 wired for electricity, and/or similar data. Data related to the construction materials used at the client site 133 may include the type and amount of insulation used at the client site 133, the number, size, type, and location of windows located at the client site 133, the materials used to construct any buildings at the client site 133, and/or other data. Data regarding the utility consuming systems located at the client site 133 may include the type, make, model, and manufacturer of any systems consuming utilities, such as the heating, ventilating and air-conditioning (HVAC) system at the client site 133, appliances located at the client site 133, water heaters located at the client site 133, toilets and/or showers located at the client site 133, industrial equipment located at the client site 133, and/or any other systems or equipment at the client site 133 capable of consuming utilities. Sales data associated with the client site 133 may include total number of sales or orders, total number of customers, average value of each sale or order, average number of customers per sale or order, total and average sales amounts and volumes, sales dollars attributable to a particular business unit, segment, and/or division, as well as other sales data corresponding to the client site 133.

Utility data 146 represents utility usage at the client site 133. Utility data 146 may be acquired from utility invoices corresponding to the client sites 133 and/or other sources as will be further discussed herein.

The client computing device 106 is representative of a plurality of client devices that may be coupled to the network 109. The client computing device 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client computing device 106 may include a display. The display may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client computing device 106 may be configured to execute various applications such as a client application 149 and/or other applications. The client application 149 may be executed in a client computing device 106, for example, to access network content served up by the computing environment 103 and/or other servers, thereby rendering a user interface on the display. To this end, the client application 149 may comprise, for example, a browser, a dedicated application, etc., and the user interface may comprise a network page, an application screen, etc. The client computing device 106 may be configured to execute applications beyond the client application 149 such as, for example, email applications, social networking applications, word processors, spreadsheets, and/or other applications.

The client computing device 106 may also include a local data store 153. Data stored in the local data store 153 may include utility data 146 for one or more client sites 133, site data 143 for one or more client sites 133, and invoice data 136 for a client.

In some embodiments, the client computing device 106 may also include one or more sensors 156. Sensors 156 may include any device capable of measuring utility usage, including electricity meters, gas meters, water meters, network connected utility meters (i.e. “smart” meters), current transformers (known as “CTs”), and/or other measuring devices. Sensors 156 may correspond to meters installed by a utility provider at a client site 133 or sensors 156 installed at the client site independent from the utility provider.

Next, a general description of the operation of the various components of the networked environment 100 is provided. To begin, a client computing device 106 initially uploads site data 143 corresponding to a client site 133 from the local data store 153 to the data store 111 in the computing environment 103 for future use by the utility optimizer 119. Subsequently, the client computing device 106 uploads utility data 146 and/or invoice data 136 related to the client site 133. The utility data 146 may be generated by sensors 156 attached to, connected to, or otherwise in communication with the client computing device 106 or generated by other sources. In some embodiments, the utility data 146 may be uploaded periodically, incrementally, and/or provided as a stream of data. The invoice data 136 may be uploaded at once and/or periodically on an ongoing basis.

Upon receiving the invoice data 136, the metadata processor 113 parses and extracts relevant data related to utility usage from the invoice data 136. This data is then converted by the invoice processor 116 into utility data 146 for the appropriate client site(s) 133 for the client.

Afterwards, the utility optimizer 119 initially analyzes the utility data 146 for a client site 133 to identify various utility usage patterns and calculate various utility usage metrics associated with the client site 133. Utility usage patterns may include quarter-hour, hourly, daily, weekly, bi-weekly, monthly, quarterly, and/or yearly utility usage at the client site 133. Utility usage patterns may also be seasonally adjusted by the utility optimizer 119 to compensate for seasonal variations in utility usage. The utility optimizer 119 also determines utility usage trends, such as week-over-week, month-over-month, year-over-year changes in utility usage and/or similar trends over other periods of time. These utility usage trends may correspond to, for example, increases or decreases in customer traffic at a client site 133 corresponding to a restaurant or store, increases or decreases in industrial activity at a factory corresponding to changes in customer orders, increases or decreases in occupancy at a hotel, and/or other changes in the use of or activity at the client site 133.

The utility optimizer 119 performs subsequent analysis on a periodic basis of the utility data 146 to identify deviations from the previously identified utility usage patterns and/or utility usage trends. These deviations may indicate maintenance problems at the client site 133, such as a leaking pipe and/or plumbing fixture, cracks in pools and fountains, malfunctioning ice makers, incorrectly configured irrigation controllers, a failing HVAC unit causing increased heating and/or cooling costs, faulty machinery and/or equipment, and/or other maintenance problems at the client site 133. In the event that such a deviation is detected, the utility optimizer 119 sends an error message to a client application executing on the client computing device 106. The error message indicates at least the client site 133 where the deviation is occurring, the nature of the deviation, and/or potentially other data that may be useful for identifying the maintenance issue at the client site 133.

The utility optimizer 119 also compares the utility data 146 with the site data 143 to identify potential efficiency gains in utility usage at the client site 133. For example, the utility optimizer 119 may determine that a floor of a hotel is unoccupied, based on available site data 143, and therefore can have a smaller utility budget allocated to heating and cooling. As another example, the utility optimizer 119 may determine that a building at a client site 133 has east facing and west facing windows and that, based on the site data 143 and the utility data 146, less electricity could be used to cool the building in summer if the blinds were closed on the east facing windows in the morning and the west facing windows in the afternoon. In response to this determination, the utility optimizer 119 may send a message to a client computing device 106 to close the blinds on the windows at specified times. Similarly, the utility optimizer 119 may determine that less electricity, heating oil, and/or gas could be used to heat the building in winter if the blinds were open on the east facing windows in the morning and the west facing windows in the afternoon.

In response to identifying an efficiency gain, the utility optimizer 119 may send an electronic message to the client computing device 106 to take an appropriate action. For example, if the client computing device 106 is in data communication with or otherwise controls the thermostat of the building, then utility optimizer 119 may send a message with instructions to change the thermostat settings, which would be implemented by the client computing device 106. Similarly, if the client computing device 106 controls a motor that operates the blinds of the windows of a building, then the utility optimizer 119 may send a message with instructions to open or close the blinds.

The utility optimizer 119 may also generate one or more reports detailing utility usage at the client site 133. These reports may be based upon utility data 146 of the client site and may, in some embodiments, make use of the site data 143. These reports may, for example, may include metrics such as utility usage per square foot, utility usage per sales dollar, utility usage per sale, utility usage per customer, and/or other utility usage metrics. Some of these metrics may be further broken down into component metrics, such as utility usage per sales dollar attributable to a specific division or department, such as a utility usage per sales dollar attributable to the kitchen of a restaurant and the utility usage per sales dollar attributable to the bar of a restaurant.

The reports generated by the utility optimizer 119 may be made available to the client computing device 106 by the utility optimizer 119. For example, the utility optimizer 119 may send the reports to the client computing device via email or a similar electronic message mechanism. The utility optimizer 119 may also make the reports available as network content, such web pages or other files, that are available for download from the data store 111 by the client application 149 executing on the client computing device 106.

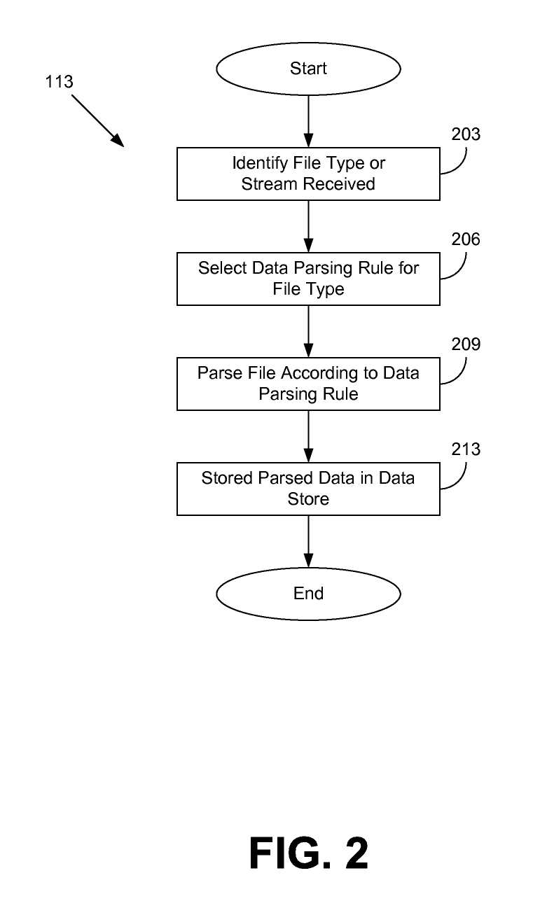

Referring next to FIG. 2, shown is a flowchart that provides one example of the operation of a portion of the metadata processor 113 according to various embodiments. It is understood that the flowchart of FIG. 2 provides merely an example of the many different types of functional arrangements that may be employed to implement the operation of the portion of the metadata processor 113 as described herein. As an alternative, the flowchart of FIG. 2 may be viewed as depicting an example of elements of a method implemented in the computing environment 103 (FIG. 1) according to one or more embodiments.

Beginning with box 203, the metadata processor 113 identifies the file type or stream type received. The metadata processor 113 may compare the file type or stream type received to one or more file identifier rules 126 (FIG. 1). If the file type or stream matches a profile contained within a file identifier rule 126, then the metadata processor 113 identifies the file type or stream type received as being the type specified in the matching file identifier rule 126.

Proceeding next to box 206, the metadata processor 113 selects an appropriate data parsing rule 123 (FIG. 1) for parsing the file or stream received. The data parsing rule 123 may be selected based on the file type or stream type identified previously at box 203 and/or the source of the file type or stream type received.

Moving on to box 209, the metadata processor 113 parses the file or stream received based on the data parsing rule 123 selected previously at box 206. Parsing may involve identifying the location of data in the file or stream as well as identifying the type of data at the location. After identifying the location and type of data, the data is extracted and stored in memory.

Referring next to box 213, the data that was parsed and extracted at box 209 is stored in the data store 111 (FIG. 1) by the metadata processor 113. In embodiments where the data store 111 corresponds to a relational database, the metadata processor 113 may make use a structured query language (SQL) statement. In embodiments where the data store 111 corresponds to a hierarchical or object-oriented database, the metadata processor 113 may create new objects or hierarchical entries corresponding to the data extracted at box 209. Similarly, the metadata processor 113 may make use of other data storage interfaces corresponding to other types of data stores 111. Execution of the metadata processor 113 subsequently ends.

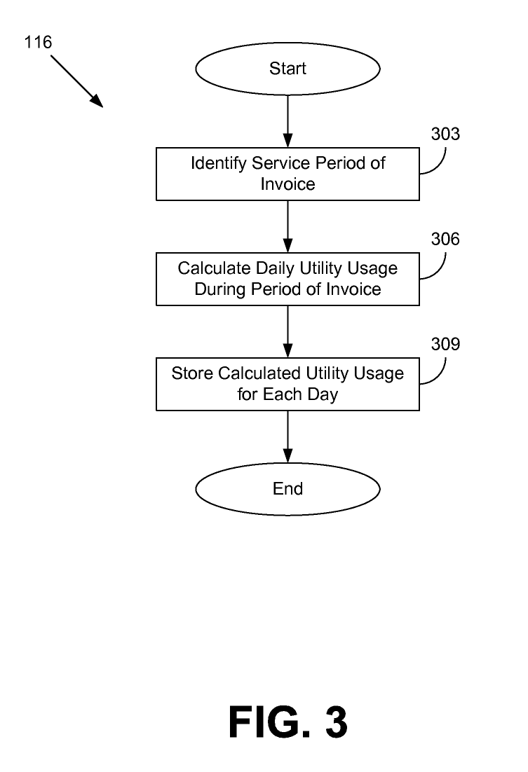

Referring next to FIG. 3, shown is a flowchart that provides one example of the operation of a portion of the invoice processor 116 according to various embodiments. It is understood that the flowchart of FIG. 3 provides merely an example of the many different types of functional arrangements that may be employed to implement the operation of the portion of the invoice processor 116 as described herein. As an alternative, the flowchart of FIG. 3 may be viewed as depicting an example of elements of a method implemented in the computing environment 103 (FIG. 1) according to one or more embodiments.

Beginning with box 303, the invoice processor 116 processes an invoice or invoice data 136 (FIG. 1) received from a client computing device 106 (FIG. 1) to identify the service period of the invoice. The invoice processor 116 may, for example, identify the start date of the calendar period billed and the end date of the calendar period billed to determine the number of days and the date range for the invoice and/or invoice data 136.

Proceeding next to box 306, the invoice processor 116 calculates the daily utility usage during the period of the invoice. This may be accomplished using a number of approaches. For example, the invoice processor 116 may divide the total amount of utilities consumed, such as the total amount of electricity, water, gas, and/or other utilities, by the number of days in the service period to generate an average daily use.

In some embodiments, the invoice processor 116 may use site data 143 (FIG. 1) to make more accurate calculations. For example, the site data 143 may indicate that a business is closed on Sundays and holidays. Therefore, the invoice processor 116 may remove these days from consideration when calculating the daily utility usage during the period of the invoice. Similarly, the site data 143 may indicate that a business located at a client site 133 (FIG. 1) is only open for reduced hours on some days and may adjust the number of days in the period of the invoice accordingly before calculating the daily utility usage. In some embodiments, the site data 143 may indicate that only part of a client site 133 is operating on some days, such as a bank only providing drive-through teller service on weekends, and will factor the reduced utility footprint on certain days into the calculation of the daily utility usage.

Moving on to box 309, the invoice processor 116 stores the calculated daily utility usage for each day in the service period of the invoice as utility data 146 (FIG. 1) for a client site 133. In embodiments where the data store 111 corresponds to a relational database, the invoice processor 116 may make use a structure query language (SQL) statement. In embodiments where the data store 111 corresponds to a hierarchical or object-oriented database, the invoice processor 116 may create new objects or hierarchical entries corresponding to the data extracted at box 209. Similarly, the invoice processor 116 may make use of other data storage interfaces corresponding to other types of data stores 111. Execution of the invoice processor 116 subsequently ends.

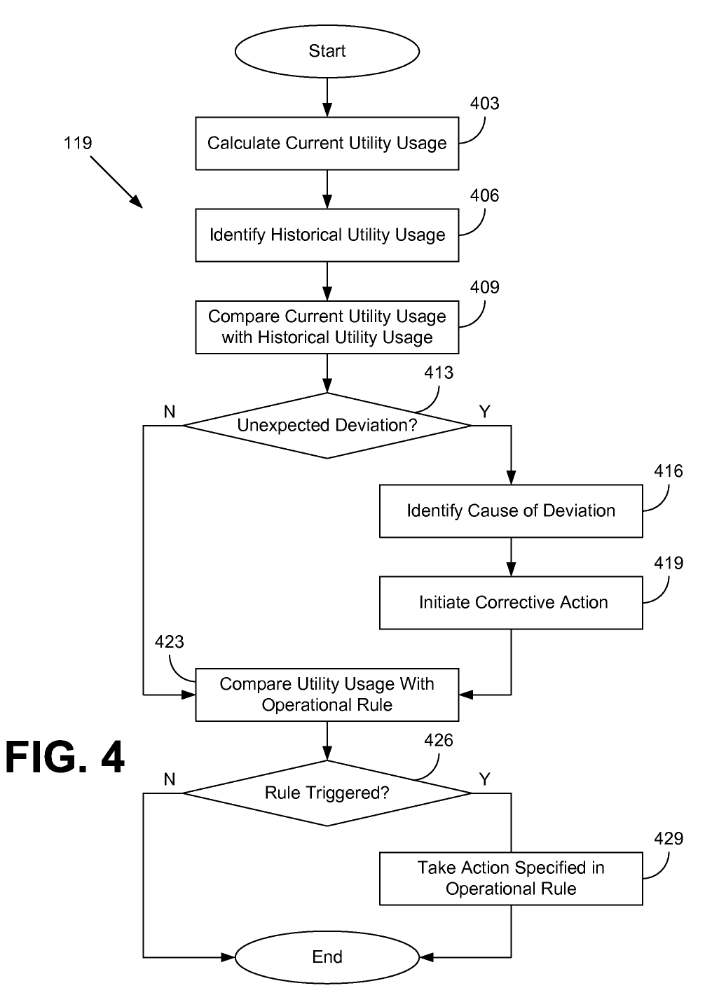

Referring next to FIG. 4, shown is a flowchart that provides one example of the operation of a portion of the utility optimizer 119 according to various embodiments. It is understood that the flowchart of FIG. 4 provides merely an example of the many different types of functional arrangements that may be employed to implement the operation of the portion of the utility optimizer 119 as described herein. As an alternative, the flowchart of FIG. 4 may be viewed as depicting an example of elements of a method implemented in the computing environment 103 (FIG. 1) according to one or more embodiments.

Beginning with box 403, the utility optimizer 119 calculates the current utility usage at a client site 133 (FIG. 1). The current utility usage may be determined in real-time, such as by receiving utility usage data from one or more sensors 156 (FIG. 1) located at the client site 133. Current utility usage may also be forecast based on historical utility data 146 (FIG. 1) for the client site 133 or otherwise based upon utility data 146 (FIG. 1) for the client site 133.

Proceeding to box 406, the utility optimizer 119 identifies historical utility usage at the client site 133. This may correspond to historical average utility usage at the client site 133 for a given day, week, month, quarter, year, and/or other time period. In some embodiments, this may also include historical trends in utility usage, such as increasing or decreasing day-over-day, week-over-week, month-over-month, quarter-over-quarter, and/or other time periods. These trends may be identified using various regression analysis techniques.

Moving on to box 409, the utility optimizer 119 compares current utility usage calculated at box 403 with the historical utility usage identified at box 406 to identify any deviation between the current utility usage and the historical utility usage. These deviations may be identified by, for example, determining whether the current utility usage at the client site 133 matches forecast utility usage at the client site 133 based on historical trends in utility usage at the client site 133. As another example, the utility optimizer 119 may determine whether the current utility usage varies from the historical average utility usage within a predefined range. Deviations between current utility usage at the client site 133 and historical utility usage at the client site 133 may be measured as a percentage difference, a quantified difference (e.g. in kilowatt-hours, gallons of water, and/or similar measurements), or as a number of statistical standard deviations from the historic amount of utility usage at the client site 133.

Referring next to box 413, the utility optimizer 119 determines whether any deviations between current utility usage at the client site 133 and historical utility usage at the client site 133 are unexpected. This determination may be based upon site data 143 previously supplied by the client for the client site 133. For example, site data 143 may indicate that an HVAC unit was replaced with a more efficient model, in which case the utility usage at the client site 133 would be expected to be lower than historical utility usage. Similarly, unexpectedly harsh weather indicated in the site data 143 may correspond to increased utility usage at the client site 133, such as increased heating requirements for an exceptionally cold winter. Increased sales or customer traffic at a client site 133 of a retail business, as indicated in the site data 143, may correspond to an increase in utility usage in order to service the additional customers. Other factors indicated in the site data 143 for a client site 133 may correspond to or otherwise explain deviations from the historical utility usage patterns. If no factors indicated in the site data 143 would correspond to or otherwise indicate a change in the current utility usage at the client site 133 from the historical utility usage at the client site 133, then execution proceeds to box 416. If deviations from the historical utility usage at the client site 133 would be explained by information in the site data 143, then execution skips to box 423.

Proceeding to box 416, the utility optimizer 119 attempts to identify the cause of the deviation of the current utility usage at the client site 133 from the historical utility usage at the client site 133. Identification of potential causes of the deviation in the current utility usage may be based at least in part on the site data 143 for the client site 133. As an illustrative and non-limiting example, the utility optimizer 119 may have previously detected, at box 413, a deviation between the current water usage and the historical water usage at a client site 133 of 90,000 gallons of water. The site data 143 may also indicate that a number of toilets are located at the client site 122. Because a toilet may consume as much as 3 gallons of water per minute when constantly running, the utility optimizer 119 may determine that one or more toilets are running continuously and are in need of repair. Similar identifications may be made for other appliances or systems.

Moving on to box 419, the utility optimizer 119 may attempt to initiate a corrective action to address the deviation in utility usage. For example, such corrective action may involve sending an electronic message, such as an email sent to the email address of the facilities manager or maintenance manager of the client site 133, a short message service (SMS) message sent to the cell phone of the facilities manager or maintenance manager of the client site 133, and/or similar messages. As another example, the utility optimizer 119 may be in data communication with various control mechanisms located at the client site 133, such that the utility optimizer 119 may control the use of utilities at the client site 133. For example, based on additional data provided by various sensors 156 (FIG. 1) at the client site 133, such as network connected flow meters connected to water pipes throughout the client site 133 and network connected electricity meters installed through the client site 133, the utility optimizer 119 may be able to identify the faulty unit, appliance, and/or system and remotely cut off or otherwise restrict utilities to the faulty unit, appliance, and/or system.

Referring next to box 423, the utility optimizer 119 compares the current utility usage at the client site 133 with one or more operational rules 139 apply. This determination may be based in part on the site data 143 and/or other data.

Proceeding next to box 426, the utility optimizer 119 determines if one or more of the operation rules 139 has been triggered. If an operational rule has been triggered, then execution proceeds to box 429. Otherwise, execution of the described portion of the utility optimizer 119 ends.

Moving on to box 429, the utility optimizer 119 takes an action specified in the operational rule 139. If the utility optimizer 119 is in data communication with various systems of the client site 133, such as the thermostats, HVAC system, automated/motorized window blinds, and/or other such systems, then the utility optimizer may cause a system at the client site 133 to operate in manner specified in the operational rule 139. For example, the utility optimizer 119 may cause the thermostats on in an unoccupied section of the client site 133 to reset to a more energy efficient temperature range. As another illustrative and non-limiting example, the utility optimizer 119 may cause the windows blinds to open or close on individual windows at the client site 133. In various embodiments, the utility optimizer 119 may send an electronic message, such as an email sent to the email address of the facilities manager or maintenance manager of the client site 133, a short message service (SMS) message sent to the cell phone of the facilities manager or maintenance manager of the client site 133, and/or similar messages, containing instructions for the recipient to follow to optimize the utility usage of the client site 133. After action specified in the operational rule 139 is taken, execution of the described sections of the utility optimizer 119 end.

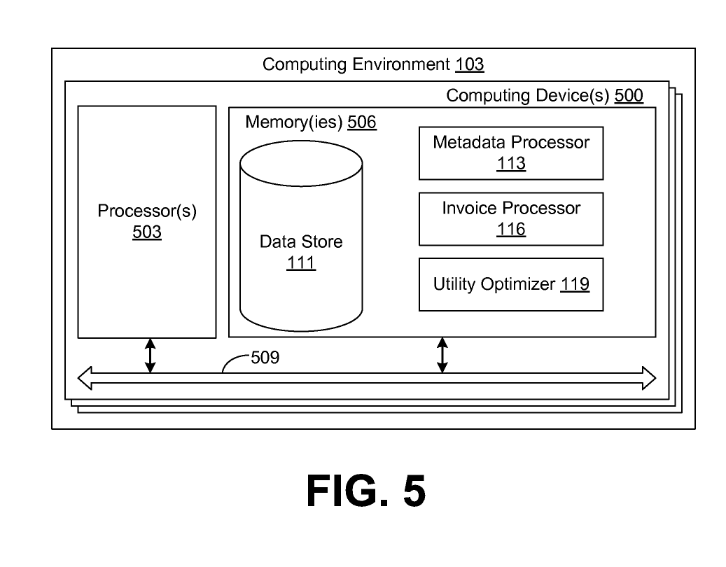

With reference to FIG. 5, shown is a schematic block diagram of the computing environment 103 according to an embodiment of the present disclosure. The computing environment 103 includes one or more computing devices 500. Each computing device 500 includes at least one processor circuit, for example, having a processor 503 and a memory 506, both of which are coupled to a local interface 509. To this end, each computing device 500 may comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are the metadata processor 113, the invoice processor 116, the utility optimizer 119, and potentially other applications. Also stored in the memory 506 may be a data store 111 and other data. In addition, an operating system may be stored in the memory 506 and executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C++, C#, Objective C, JavaScript®, Perl®, Python®, AJAX, native assembly language, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the metadata processor 113, the invoice processor 116, the utility optimizer 119, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2, 3, and 4 show the functionality and operation of an implementation of portions of the metadata processor 113, the invoice processor 116, and the utility optimizer 119. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 2, 3, and 4 show a specific order of execution, it is understood that the order of execution may differ from that which is depicted. For example, the order of execution of two or more blocks may be scrambled relative to the order shown. Also, two or more blocks shown in succession in FIGS. 2, 3, and 4 may be executed concurrently or with partial concurrence. Further, in some embodiments, one or more of the blocks shown in FIGS. 2, 3, and 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including metadata processor 113, the invoice processor 116, the utility optimizer 119, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the metadata processor 113, the invoice processor 116, the utility optimizer 119, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, comprising:
code that parses utility billing data to identify a current utility consumption rate for a property;
code that analyzes property data to determine an optimum utility consumption rate for the property;
code that determines that the current utility consumption rate for the property exceeds the optimum utility consumption rate for the property; and
code that identifies a potential cause of the current utility consumption rate for the property exceeding the optimum utility consumption rate for the property, wherein the potential cause is identified based at least in part on property data for the property.

2. The non-transitory computer-readable medium of claim 1, wherein the program further comprises code that sends an electronic message to a client computing device associated with the property, wherein the electronic message comprises a notification of the current utility consumption rate for the property and the potential cause of the current utility consumption rate for the property exceeding the optimum utility consumption rate for the property.

3. The non-transitory computer-readable medium of claim 1, wherein the program further comprises code that normalizes the utility billing data on a calendar month basis.

4. The non-transitory computer-readable medium of claim 1, wherein the program further comprises:
code that encodes within a page at least one of: the utility billing data, the current utility consumption rate for the property and the optimum utility consumption rate for the property, or the potential cause of the current utility consumption rate for the property exceeding the optimum utility consumption rate for the property; and
code that sends the page to a client computing device for rendering on a display of the client computing device in response to receiving a request from the client computing device for the page.

5. The non-transitory computer-readable medium of claim 1, wherein the current utility consumption rate corresponds to a current water consumption rate for the property and the optimum utility consumption rate corresponds to an optimum water consumption rate for the property.

6. The non-transitory computer-readable medium of claim 1, wherein the currently utility consumption rate corresponds to a current electricity consumption rate for the property and the optimum utility consumption rate corresponds to an optimum electricity consumption rate for the property.

7. A system, comprising:
at least one data store, comprising property data corresponding to a property;
at least one computing device in data communication with the at least one data store; and
an application executed in the at least one computing device, the application comprising:
logic that parses utility consumption data for the property to determine a current utility consumption rate for the property, wherein the utility consumption data is generated by at least one sensor located on the property;
logic that analyzes the property data to determine an optimum utility consumption rate for the property;
logic that determines that the current utility consumption rate for the property is greater than the optimum utility consumption rate for the property; and
logic that restricts utility usage for the property to match the current utility consumption rate for the property to the optimum utility consumption rate for the property.

8. The system of claim 7, wherein the current utility consumption rate corresponds to a current water consumption rate for the property and the optimum utility consumption rate corresponds to an optimum water consumption rate for the property.

9. The system of claim 7, wherein the currently utility consumption rate corresponds to a current electricity consumption rate for the property and the optimum utility consumption rate corresponds to an optimum electricity consumption rate for the property.

10. The system of claim 7, wherein the property data comprises at least one of: a list of electricity consuming appliances located on the property, weather data for the property, micro-climate data for the property, interior square footage of at least one building on the property, a list of systems used at the property, a list of devices used at the property, or data defining construction materials used for the at least one building on the property.

11. The system of claim 7, wherein the logic that restricts utility usage for the property further comprises:
logic that identifies an unused section of the property based at least in part on the property data; and
logic that terminates at least one utility to the unused section of the property.

12. The system of claim 7, wherein the logic that restricts utility usage for the property further comprises:
logic that identifies an unused section of the property based at least in part on the property data; and
logic that adjusts a system servicing the unused section of the property to cause the system to use less of a resource corresponding to the current utility consumption rate for the property.

13. The system of claim 7, wherein the system comprises a heating, ventilating, and air conditioning (HVAC) system and the logic that adjusts the system servicing the unused section of the property to use less of the resource corresponding to the current utility consumption rate further comprises:
logic that identifies a weather forecast for a micro-climate at the property; and
logic that sends an electronic message across a network to the HVAC system, wherein the electronic message adjusts a threshold temperature that triggers operation of the HVAC system.

14. The system of claim 7, wherein the application further comprises:
logic that generates a report comprising the current utility consumption rate for the property; and
logic that sends the report to a client computing device associated with the property.

15. A computer-implemented method, comprising:
parsing, via a computing device, utility billing data for a property to generate utility consumption data for the property to determine a current utility consumption rate for the property;
analyzing, via the computing device, property data for the property to determine an optimum utility consumption rate for the property;
determining, via the computing device, that the current utility consumption rate for the property is greater than the optimum utility consumption rate for the property;
determining, via the computing device, a list of solutions to reduce the current utility consumption rate for the property to the optimum utility consumption rate for the property; and
sending, via the computing device, an electronic message to a client computing device associated with the property, wherein the electronic message comprises the list of solutions to reduce the current utility consumption rate for the property to the optimum utility consumption rate for the property.

16. The computer-implemented method of claim 15, further comprising importing, via the computing device, the property data for the property from a remote data store, wherein the remote data store is associated with the property.

17. The computer-implemented method of claim 15, further comprising normalizes the utility billing data on a calendar month basis.

18. The computer-implemented method of claim 15, wherein the list of solutions are based at least in part on the property data.

19. The computer-implemented method of claim 15, wherein the currently utility consumption rate corresponds to a current electricity consumption rate for the property and the optimum utility consumption rate corresponds to an optimum electricity consumption rate for the property.

20. The computer-implemented method of claim 15, wherein the currently utility consumption rate corresponds to a current electricity consumption rate for the property and the optimum utility consumption rate corresponds to an optimum electricity consumption rate for the property.
